(19) United States
(12) Patent Application Publication
(10) Pub. No.: US 2022/0073089 A1
(43) Pub. Date: Mar. 10, 2022

(54) OPERATING SYSTEM WITH PORTABLE INTERFACE UNIT, AND MOTOR VEHICLE HAVING THE OPERATING SYSTEM

(71) Applicant: AUDI AG, Ingolstadt (DE)

(72) Inventors: Daniel LOTTES, Ihrlerstein (DE); Philipp WEIß, Düsseldorf (DE)

(73) Assignee: AUDI AG, Ingolstadt (DE)

(21) Appl. No.: 17/423,650

(22) PCT Filed: Dec. 17, 2019
(86) PCT No.: PCT/EP2019/085809

§ 371 Date: Jul. 16, 2021

(30) Foreign Application Priority Data
Jan. 18, 2019 (DE) 10 2019 200 632.9

(51) Int. Cl. B60W 50/14; G06K 9/00

(52) U.S. Cl. CPC B60W 50/14; G06K 9/00805; B60K 2370/77; B60W 2050/146; B60K 2370/143; B60W 2420/42

(57) ABSTRACT

An operating system for a motor vehicle includes an interface having an operating surface and a projector configured to project display content onto the operating surface of the interface. The interface is a portable item freely movable in the motor vehicle. The operating system further includes a capturing device configured to determine an inclination vector of a relative inclination of the operating surface with respect to the projector, and an image processing device configured to generate the display content by graphically distorting an original display content by use of a predetermined pre-distortion function based on the determined inclination vector. The pre-distortion function is set inversely to an optical distortion that occurs due to the relative inclination of the operating surface during the projection of the display content onto the operating surface.

### CROSS-REFERENCE TO RELATED APPLICATIONS

This application is a U.S. national stage of International Application No. PCT/EP2019/085809, filed on Dec. 17, 2019. The International Application claims the priority benefit of German Application No. 10 2019 200 632.9 filed on Jan. 18, 2019. Both International Application No. PCT/EP2019/085809 and German Application No. 10 2019 200 632.9 are incorporated by reference herein in their entirety.

### BACKGROUND

Described herein is an operating system for a motor vehicle, by which display content can be displayed to a user on a user interface, which is referred to herein as an interface unit. The interface unit may be embodied in the form of a portable remote control, that is to say as a portable item that is freely movable in the motor vehicle. Also described herein is a motor vehicle having such an operating system.

An occupant or user may be enabled in a motor vehicle to move the vehicle seat into a lying or relaxing position, in which the backrest of the seat is inclined backward compared to a normal upright seat position. This can also be made possible for the driver, for example, for a piloted journey. If a user then leans back into the vehicle seat, the manual operation of operating elements for example on the control panel becomes impossible due to the increased distance, or the user is required to sit upright again in the vehicle seat.

In order to avoid this, a remote control may be provided in the motor vehicle, which the user can use even when they are in the reclined lying position in order to operate at least one vehicle component, that is to say, for example, a media reproduction for playing music contents or video contents. However, such a remote control represents a loose object that may slip in the motor vehicle, for example when negotiating curves and/or during braking and/or during acceleration, and may fall under a seat, for example. In addition, such a loose subject should be prevented from falling against a person, which might be painful in the case of a firm shell case of a remote control.

Therefore, an operating system that allows the operation of at least one vehicle component in the motor vehicle even in a reclined position of the user, without a remote control having a firm shell case being necessary, is of interest.

U.S. Pat. No. 8,723,787 B2 describes an operating system, which, first, has a projection plate that a user can hold in their hand, and, second, provides a plurality of projectors, which can alternately project a display image on the projection plate. The projection is effected by the projector that has a favorable projection angle onto the projection plate. In this way, an optical distortion that would otherwise come about in the case of an oblique projection plate is minimized. A drawback of this system is that a plurality of projectors are needed if such a projection plate is intended to be able to be held at different holding angles in a motor vehicle by the user. This requires too much installation space.

U.S. Pat. No. 8,509,986 B1 describes a projection system for a car repair workshop, projecting display content and operating fields for inputting a user input onto a projection surface. In this way it is possible in the car repair workshop to use, for example, a floor in the workshop or a plate of a workbench as the projection surface for reading and operating a diagnosis computer of a motor vehicle.

### SUMMARY

Described herein is an operating system in a motor vehicle for use of at least one vehicle component.

This may be achieved by the operating system and the motor vehicle described herein. Advantageous embodiments are further described according to the following description, and the drawings.

Described herein is an operating system fora motor vehicle. In the manner described in the introductory part, the operating system has an interface unit having an operating surface and a projection unit. The projection unit is configured to project display content, for example an operating menu or media content, onto the operating surface of the interface unit from the outside. “From the outside” is intended to mean that the projection unit is not integrated into the interface unit and backlights the operating surface from inside, but rather that the projection unit can be arranged or provided separately from the interface unit in the motor vehicle and the projection unit shines light on or illuminates the operating surface from the outside so as to present the display content. The interface unit may be embodied in the form of a portable item that is freely movable in the motor vehicle. This can be, for example, a board or, for example for children, a figure.

A plurality of different projection units are not necessary in the operating system described herein in order to continue to project the display content onto the operating surface when the spatial position of the interface unit moves or changes. Instead, a capturing device is configured to ascertain an inclination vector of a relative inclination of the operating surface with respect to the projection unit. In other words, the capturing device is used to ascertain the incline or relative orientation of the operating surface with respect to the projection unit. Consequently, for example, the angle at which the projection surface is arranged or aligned with respect to a projection direction of the projection unit is thus known. In addition, it is also possible by way of the capturing device to ascertain a distance of the operating surface from the projection unit.

In the operating system, an image processing device is configured to generate the display content, which is projected onto the operating surface, by virtue of the fact that the image processing device graphically distorts original display content by use of a predetermined pre-distortion function in dependence on the ascertained inclination vector. In other words, the display content is based on original display content, that is to say for example on graphics data or image data that present or describe the display content in the undistorted state or original state. A pre-distortion function is used to create therefrom the display content to be projected that is graphically distorted, that is to say for example is stretched or compressed in one direction. The pre-distortion function is set here inversely to an optical distortion that arises during the projection of the display content onto the operating surface due to the inclination. The reason is that the display content being projected onto the operating surface that is aligned obliquely or at an incline with respect to the projection direction results in a distortion, for example a change in length. The pre-distortion function adds or contributes an inverse distortion to the display content. Due to the inverse distortion (that is to say the pre-distortion) according to the pre-distortion function and the subsequent optical distortion occurring during the projection of the display content onto the operating surface, the original display content is thus formed again overall on the operating surface, that is to say distortion-free reproduction. In other words, due to the graphic pre-distortion, the pre-distortion function compensates for the optical distortion that will arise during the projection of the display content onto the inclined operating surface. The pre-distortion or inverse distortion is thus a digital or data-technological process, while the optical distortion arises physically on the operating surface. Consequently, the incline of the interface unit with respect to the projection unit is compensated to the effect that a continuously adapted display unit is dynamically presented or projected for the user as the inclination changes, with the result that the projected display content is presented without change or is made readable or perceivable for the user without distortion even if the inclination of the interface unit changes.

One or more advantages include that, despite the use of an individual projection unit that projects the display content onto the interface unit always from the same direction in the motor vehicle, an optical distortion that would otherwise reproduce the original display content incorrectly if the interface unit is inclined with respect to the projection unit can nevertheless be compensated for. This compensation is also referred to here as “dynamic projection mapping.”

Also described herein are embodiments that give rise to additional advantages.

In an embodiment, the interface unit has a plurality of possible operating surfaces, for example one each on a front side and a rear side. The capturing device is configured to select, as the current operating surface, that one of the possible operating surfaces whose normal vector has the smallest angle with respect to a connecting line between the interface unit and the projection unit. In other words, the operating surface facing the projection unit, that is to say having its normal vector pointing closest to the projection unit, is selected. The respective normal vector of the possible operating surface is an (imaginary) vector that is aligned perpendicularly on the respective operating surface. Choosing between different, possible operating surfaces offers the advantage that, if an inclination of an operating surface is too extreme, in which case the pre-distortion function could then no longer compensate for the optical distortion brought about by the projection, another operating surface can be used.

In an embodiment, a predetermined original display content is assigned to each of the possible operating surfaces. In this case, a different original display content is provided for each possible operating surface. The image processing device, which generates the actual display content to be projected from the respective original display content by use of the pre-distortion function, is configured to select the assigned original display content depending on which of the possible operating surfaces is selected as the current operating surface used. In other words, the interface unit can have a multifunctional design by virtue of a different original display content being provided for each possible operating surface. By inverting or tilting the interface unit, a user can then choose between the different original display contents. For example, an operating menu or an output of a first vehicle component of the motor vehicle can be assigned as the original display content, and an operating menu or an output of another, second vehicle component of the motor vehicle can be assigned to a second operating surface. For example, the user can switch between an operating menu of an air-conditioning device of the motor vehicle and a video reproduction device.

In an embodiment, the capturing device, which is intended to ascertain the inclination vector, includes at least one recognition feature provided or arranged at the interface unit and a sensor device, which is located at a distance from the interface unit, that is to say is different therefrom, and is sensitive to the at least one recognition feature. The sensor device can thus sense or capture in the motor vehicle the at least one recognition feature at the interface unit from the outside. The sensor device is configured to ascertain the inclination vector by contactlessly detecting a spatial orientation of the at least one recognition feature. In other words, the capturing device can, by use of its sensor device, use the at least one recognition feature in order to determine the inclination vector. In this way, the at least one recognition feature is captured with respect to its orientation in space, that is to say the relative orientation or position of the at least one recognition feature with respect to the sensor device is ascertained. The at least one recognition feature can include at least one marker element assigned at the interface unit, for example a light-emitting diode for light in the visible spectrum and/or in the infrared range, and/or a sticker and/or a graphic marker or texture. As the recognition feature, a shape of the interface unit that is known in advance, for example the three-dimensional shape and/or contour or outline thereof, can be additionally or alternatively used as the basis. For example a camera or a plurality of cameras can be provided as a sensor device.

In an embodiment, provision is also made for the user to be able to provide or input an operating input at the interface unit. For this purpose, an input device is configured to capture the operating input that the user performs at the interface unit and to generate, in dependence on the captured operating input and on a currently running operating function determining the current original display content, a control signal for controlling at least one vehicle component of the motor vehicle. In dependence on which operating function (for example the air-conditioning unit, media reproduction, seat positioning system, telephony, infotainment, and the like) is currently running or activated and in dependence on which operating input the user inputs at the interface unit, a control signal by way of which the at least one vehicle component that is controlled by the operating function is controlled or starts or configures a function therein is correspondingly generated. The user can thus view on the interface unit the display content that presents or displays for example an operating menu and/or at least one operating area or button and can then correspondingly initiate an operating function by touching the interface unit at a location at which a menu entry or an operating area is projected.

In an embodiment, the input device includes what is known as a time-of-flight camera, which can generate three-dimensional image data of the interface unit and the surrounding area thereof. The input device is configured to capture the operating input by way of the image data that are generated by the TOF camera and describe a relative position of an input element of the user with respect to the interface unit. In other words, the three-dimensional image data of the TOF camera are used to identify where the input element touches the interface unit or to which part of the interface unit the input element points. The input element that can be used by a user may be, for example, a finger or a plurality of fingers or a hand or a pen. Additionally or alternatively to the TOF camera, the input device can include a touchpad arranged at the interface unit. Such a touchpad allows a touch and/or approach to be captured in a spatially resolved manner (touch location capturing with XY coordinates). A touchpad can be provided, for example, with a plurality of capacitive proximity sensors and/or touch sensors on the basis of a capacitive sensor system. As a result, touch sensing or contact sensing by use of the input device at the interface unit is advantageous overall.

In an embodiment, the interface unit is made from an elastic material. This offers the advantage that the interface unit is resilient and/or deforms upon a collision with a person, whereas in the unloaded state or force-free state, it assumes a predetermined original shape in which the operating surface has a predetermined geometric property. Additionally or alternatively to an elastic material, the interface unit may be formed from a foam and/or be equipped with an artificial leather (for example Alcantara). The use of a foam has the advantage that the interface unit has a lower inherent weight then a body having the same volume made from a solid material. The use of an artificial leather has the advantage that the interface unit can be held in one hand without slipping.

In an embodiment, the interface unit has exclusively rounded corners and edges, with a radius of curvature of greater than five millimeters, in an external profile, that is to say at an exterior surface. In other words, the interface unit only has blunt corners and edges. In this way, mechanical load peaks, as can occur at a corner or edge having a smaller radius of curvature, are avoided.

In an embodiment, the operating surface is white. In other words, a neutral color, specifically white, is provided for the operating surface. In this way, any color distortion of the display content during projection or presenting on the operating surface is avoided.

In an embodiment, the interface unit is embodied in the form of a plate having a planar operating surface. The planar design of the operating surface has the advantage that any additional optical distortion due to unevennesses of the operating surface is avoided.

Also described herein is a motor vehicle, in which the operating system described herein is provided. The motor vehicle described herein may for example, be embodied in the form of a motorized vehicle, for example a passenger car or truck, or as a minibus. It is of course also possible for an arrangement of a plurality of operating systems of the described type to be provided in the motor vehicle, which means that a plurality of passengers of the motor vehicle can be equipped with an interface unit.

Also part of the disclosure are the combinations of the features of the described embodiments.

### BRIEF DESCRIPTION OF THE DRAWINGS

These and other aspects and advantages will become more apparent and more readily appreciated from the following description of example embodiments, taken in conjunction with the accompanying drawings, of which:

FIG. 1 is a schematic illustration of an embodiment of the motor vehicle according to an example of the disclosure; and

FIG. 2 is a schematic illustration of an operating system, as may be provided in the motor vehicle of FIG. 1, according to an example of the disclosure.

### DETAILED DESCRIPTION

The example embodiments discussed below are examples of the disclosure. In the example embodiments, the described components of the embodiments each represent individual features that should be considered independently of one another and also develop the disclosure in each case independently of one another. The disclosure is therefore also intended to include combinations of the features of the embodiments other than those illustrated. Furthermore, the described embodiments may also be supplemented by further features that have already been described.

In the drawings, identical reference signs each denote elements of identical function.

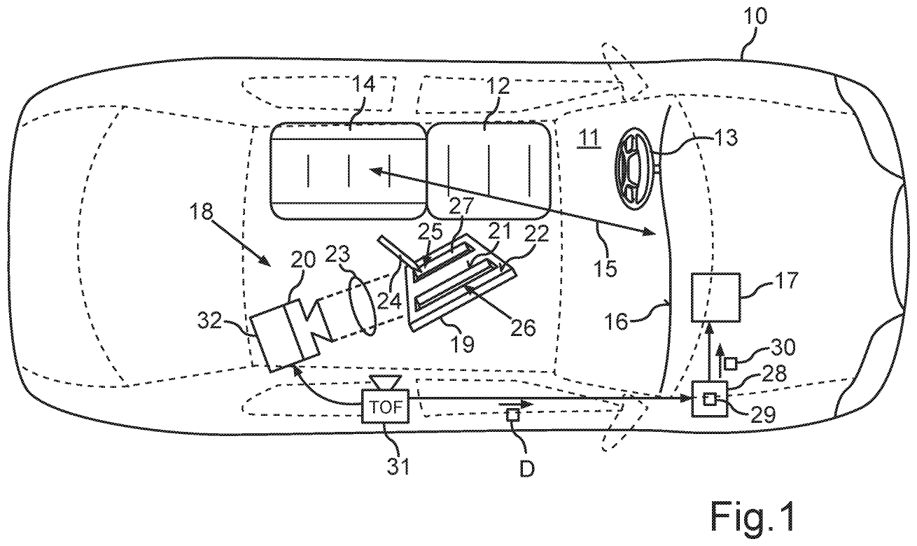

FIG. 1 shows a schematic illustration of a passenger compartment 11 from a bird's eye perspective of a motor vehicle 10. For reference purposes, a vehicle seat 12 and a steering wheel 13 are shown. The vehicle seat 12 can be set in a lying position, in which a backrest 14 of the vehicle seat 12 is inclined backward or pivoted toward the ground when compared to an upright seat position. In this way, a distance 15 between the shoulder of a user (not illustrated) lying in the vehicle seat 12 and for example a control panel 16 can be so great that the user can no longer reach the control panel 16 using their arm while in the lying position. Nevertheless, the user in the motor vehicle 10 is enabled to operate at least one vehicle component 17 from the vehicle seat 12 in the lying position and/or to view the output thereof.

For this purpose, an operating system 18 is provided in the motor vehicle 10, which, first, provides a portable interface unit 19 for the user that the user can hold in one hand, for example, and, second, provides a projection unit 20, which can project a display content 21 onto an operating surface 22 of the interface unit 19 by use of light 23. The projection unit 20 can be provided at a distance from the interface unit 19 in the motor vehicle 10, for example it may be arranged on a ceiling of the passenger compartment 11. The user can provide an operating input 25 at the operating surface 22 by use of an input element 24. For example, the display content 21 can present an operating menu 26, and the user can use the input element 24 to select or activate a menu element or an operating area 27 of the operating menu 26. An input device 28 can register the operating input 25, and, in dependence on the operating input 25 and a currently activated operating function 29, the input device 28 can generate a control signal 30 for the at least one vehicle component 17 so as to control the at least one vehicle component 17 in accordance with the selection or operating input 25 made by the user.

A touchpad can be provided at the interface unit 19 itself as an integral part of the input device 28. As an alternative, the interface unit 19 can be entirely without sensors and/or completely free from any electronic components. For example, the interface unit 19 may be a plate made of a plastics material. The input device 28 can in that case may capture the operating input 25 by use of a capturing device 31, for example a TOF camera, a relative orientation of the input element 24 with respect to the interface unit 19. The TOF camera can generate image data D of the passenger compartment 11 in which the interface unit 19 and the surrounding area thereof are mapped or described. The TOF camera can for example be a time-of-flight camera.

Since the display content 21 is projected onto the operating surface 22, an optical distortion of the display content 21 occurs in dependence on the angle or the inclination at which the operating surface 22 is held with respect to the projection unit 20. The reason for this is that, depending on the inclination of the operating surface 22, the light 23 is incident thereon obliquely.

Nevertheless, the user in the motor vehicle 10 with its operating system 18 will perceive a display content 21, the distortion of which does not change or remains unchanged if the user moves or pivots or tilts the interface unit 19 in a manner such that the inclination thereof relative to the projection unit 20 changes. The reason is that “dynamic projection mapping” is provided, for which an image processing device 32 may be provided in the operating system 18.

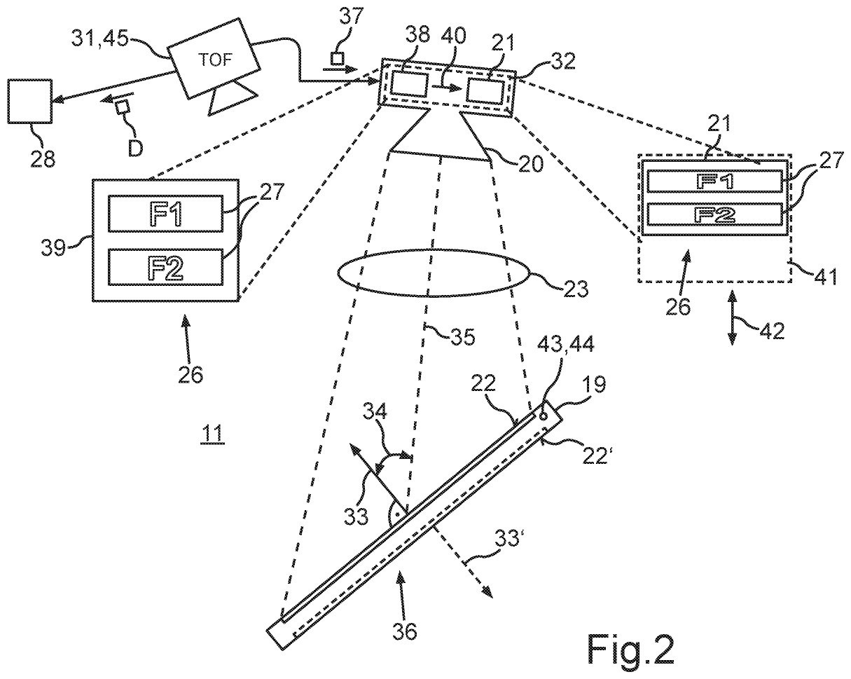

One possible mode of operation of the image processing device 32 is described in connection with FIG. 2.

FIG. 2 again schematically illustrates a side view of the projection unit 20, the interface unit 19, the capturing device 31 for example in the form of the camera, for example the TOF camera, and the image processing device 32. The image processing device 32 can be provided for example on the basis of a processor device with at least one microprocessor and/or at least one microcontroller. The method operations described can be realized on the basis of software for the processor device. The software can be stored in a data memory of the processor device.

FIG. 2 shows how the operating surface 22 of the interface unit 19 can be aligned obliquely with respect to the projection unit 20 in the passenger compartment 11, as a result of which a normal vector 33 of the operating surface 22 is aligned at a non-zero inclination angle 34 with respect to a connecting line 35 between the interface unit 19 and the projection unit 20.

This relative inclination 36 of the interface unit 19 with respect to the projection unit 20 can be captured by the capturing device 31 and be described or indicated as an inclination vector 37 by the image processing device 32. The inclination vector 37 can describe an alignment of the normal vector 33 in space. The display content 21 can be formed by the image processing device 32 on the basis of an original display content 38, with respect to which for example graphics data may be stored. A presentation 39 of the original display content 38 is likewise illustrated by way of example in FIG. 2. It is shown how, in the presentation 39 of the original display content 38, the operating menu 26 with the operating areas 27 for example for two different operating functions F1, F2 can be represented and presented without distortion.

In order to compensate for the optical distortion during the projection of the light 23 onto the operating surface 22, the display content 21 can be generated, that is to say corresponding digital image data can be calculated, by the image processing device 32 from the original display content 38 by use of a pre-distortion function 40. FIG. 2 illustrates a presentation 41 of the pre-distorted display contents 21, which has not yet been projected. It can be seen that the operating menu 26 is shown to be compressed along one spatial direction 42. The pre-distortion function 40 is obtained from the geometric conditions as they occur for the incident light 23 on the operating surface 22 due to the inclination vector 37. As a general rule, what is known as oblique parallel projection can be used as the basis here.

When projecting the compressed presentation 41 of the original display content 38 onto the operating surface 22 by use of the light 23, a projection or presentation that corresponds to the presentation 39 of the original display content 38 can be obtained on the operating surface 22 due to the optical distortion in the form of stretching.

The interface unit 19 can have at least one further operating surface 22′, so that two possible operating surfaces 22, 22′ are provided. The operating surface 22′ can also have a corresponding normal vector 33′. The corresponding associated operating surface 22, 22′ is selected for projecting the display content 21 depending on the normal vector 33, 33′ that has the smaller inclination angle 34 toward the connecting line 35. The angle 34 can be ascertained for example by use of the capturing device 31. In order to identify which operating surface 22, 22′ is located where, at least one recognition feature 43 (for example a marker element 44) may be provided at the interface unit 19. In the illustrated example, the capturing device 31 can use for example the camera TOF as the sensor device 45 for capturing the recognition feature 43.

The operating system 18 thus provides hardware that for example has a white operating surface for the purpose of projecting a user interface that is capable of being operated onto the operating surface. At the same time, the operating surface is movable because it is arranged on a portable interface unit 19. Despite the movability, the display of the operating interface remains undistorted, which is achieved by use of “dynamic projection mapping” in the manner described above.

By using an algorithm for “dynamic projection mapping”, an operating surface can be projected onto a (for example) single-color surface. The surface for example has the size of a tablet. This surface, which may not be spatially fixed, can be moved freely within the vehicle. Owing to the described possible material selection, the interface unit can have a crash-proof design, which means that it does not break in the case of an accident or crash. There is also no need for any electronic system or glass to be incorporated.

The operating surface can be detected due to its shape or by way of a marker, for example in camera-based fashion.

The operating actions taking place on the operating surface (for example touch gestures) can be captured by a TOF camera or by different tracking technology.

The projection takes place for example using a projector of the projection unit. The projection is adapted to the change in location of the surface. The change in location is here likewise captured for example by a TOF camera or by different tracking technology.

The processed signals can in turn control the vehicle-side vehicle components (for example the infotainment).

The examples show overall how a portable interface unit can be operated as a virtual tablet as described herein.

A description has been provided with reference to various examples, but it will be understood that variations and modifications can be effected within the spirit and scope of the claims which may include the phrase “at least one of A, B, and C” as an alternative expression that means one or more of A, B, and C may be used, contrary to the holding in Superguide v. DIRECTV, 358 F3d 870, 69 USPQ2d 1865 (Fed. Cir. 2004). As an example, the scope of the expression “at least one of A, B, and C” is intended to include: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

1.-10. (canceled)

11. An operating system fora motor vehicle, comprising:
a portable interface, movable in the motor vehicle, having an operating surface;
a projector, separate from the interface, configured to project display content onto the operating surface of the interface;
a capturing device configured to determine an inclination vector of a relative inclination of the operating surface with respect to the projector; and
an image processing device configured to generate the display content by graphically distorting an original display content by use of a predetermined pre-distortion function based on the determined inclination vector, the pre-distortion function being set inversely to an optical distortion that occurs due to the relative inclination during the projection of the display content onto the operating surface.

12. The operating system according to claim 11, wherein
the interface includes a plurality of operating surfaces, and
the capturing device is configured to select, as the operating surface onto which the display content is to be projected, an operating surface among the plurality of operating surfaces having a normal vector with a smallest inclination angle defined with respect to a connecting line between the interface and the projector.

13. The operating system according to claim 12, wherein
a respective original display content is assigned to each of the plurality of operating surfaces, and
the image processing device is configured to select the original display content based on which of the plurality of operating surfaces is selected as the operating surface onto which the display content is to be projected.

14. The operating system according to claim 11, wherein
the capturing device includes a recognition feature, which is provided at the interface, and
the recognition feature includes at least one of a marker element, disposed at the interface unit, and a predetermined shape of the interface, and
the operating system further comprises a sensor device, disposed at a distance from the interface and sensitive to the recognition feature, wherein the sensor device is configured to determine the inclination vector by contactlessly detecting a spatial orientation of the recognition feature.

15. The operating system according to claim 11, further comprising an input device configured to:
capture an operating input that a user performs at the interface, and
generate, based on a currently running operating function of the motor vehicle and the captured operating input, a control signal to control a vehicle component of the motor vehicle.

16. The operating system according to claim 15, wherein the input device includes at least one of:
a time of flight (TOF) camera configured to capture the operating input based on image data that are generated by the TOF camera and describe a relative position of an input element of the user with respect to the interface, and
a touchpad disposed at the interface.

17. The operating system according to claim 11, wherein the interface is made from at least one of an elastic material, a foam, and an artificial leather.

18. The operating system according to claim 11, wherein the interface includes exclusively rounded corners and edges, with a radius of curvature of greater than 5 millimeters, in an external profile.

19. The operating system according to claim 11, wherein at least one of:
the operating surface is white, and
the interface is plate-shaped and the operating surface is planar.

20. A motor vehicle, comprising:
a passenger compartment; and
an operating system, including:
a portable interface, movable in the passenger compartment, having an operating surface,
a projector, separate from the interface, configured to project display content onto the operating surface of the interface,
a capturing device configured to determine an inclination vector of a relative inclination of the operating surface with respect to the projector, and
an image processing device configured to generate the display content by graphically distorting an original display content by use of a predetermined pre-distortion function based on the determined inclination vector, the pre-distortion function being set inversely to an optical distortion that occurs due to the relative inclination during the projection of the display content onto the operating surface.

21. The motor vehicle according to claim 20, wherein
the interface includes a plurality of operating surfaces, and
the capturing device is configured to select, as the operating surface onto which the display content is to be projected, an operating surface among the plurality of operating surfaces having a normal vector with a smallest inclination angle defined with respect to a connecting line between the interface and the projector.

22. The motor vehicle according to claim 21, wherein
a respective original display content is assigned to each of the plurality of operating surfaces, and
the image processing device is configured to select the original display content based on which of the plurality of operating surfaces is selected as the operating surface onto which the display content is to be projected.

23. The motor vehicle according to claim 20, wherein
the capturing device includes a recognition feature, which is provided at the interface,
the recognition feature includes at least one of a marker element, disposed at the interface unit, and a predetermined shape of the interface, and
the operating system further includes a sensor device, disposed at a distance from the interface and sensitive to the recognition feature, wherein the sensor device is configured to determine the inclination vector by contactlessly detecting a spatial orientation of the recognition feature.

24. The motor vehicle according to claim 20, further comprising a vehicle component,
wherein
the operating system further includes an input device configured to:
capture an operating input that a user performs at the interface, and
generate, based on a currently running operating function of the motor vehicle and the captured operating input, a control signal to control the vehicle component.

25. The motor vehicle according to claim 24, wherein the input device includes at least one of:
a time of flight (TOF) camera configured to capture the operating input based on image data that are generated by the TOF camera and describe a relative position of an input element of the user with respect to the interface, and
a touchpad disposed at the interface.

26. The motor vehicle according to claim 20, wherein the interface is made from at least one of an elastic material, a foam, and an artificial leather.

27. The motor vehicle according to claim 20, wherein the interface includes exclusively rounded corners and edges, with a radius of curvature of greater than 5 millimeters, in an external profile.

28. The motor vehicle according to claim 20, wherein at least one of:
the operating surface is white, and
the interface is plate-shaped and the operating surface is planar.
